(19) United States
(12) Patent Application Publication
(10) Pub. No.: US 2025/0145086 A1
(43) Pub. Date: May 8, 2025

(54) Base for Rear-Mounted Bicycle Rack, Ski Rack, Baggage Rack, Baggage Carrier for Motor Vehicle

(71) Applicant: Martina Peruzzo, Romano D'Ezzelino (IT)

(72) Inventor: Michele Fiorese, Bassano Del Grappa (IT)

(21) Appl. No.: 18/939,728

(22) Filed: Nov. 7, 2024

(30) Foreign Application Priority Data
Nov. 8, 2023 (IT) 102023000023448

(51) Int. Cl. B60R 9/06; B60R 9/10; B60R 9/12

(52) U.S. Cl. CPC B60R 9/06; B60R 9/10; B60R 9/12

(57) ABSTRACT

A base for a rear-mounted bicycle rack, ski rack, baggage rack, or baggage carrier for a motor vehicle includes: a portion for association with a tow hook of the motor vehicle; and a frame. The base includes means for a horizontal translation of the frame, and means for a rotation of the frame about a substantially horizontal axis.

### CROSS-REFERENCE TO RELATED APPLICATION

This application claims priority to and the benefit of Italian Patent Application No. 102023000023448 filed Nov. 8, 2023, the disclosure of which is incorporated herein by this reference in its entirety.

### FIELD OF THE DISCLOSURE

The present invention relates to a base for a rear-mounted bicycle rack, ski rack, baggage rack, baggage carrier for a motor vehicle.

### BACKGROUND OF THE DISCLOSURE

Nowadays, apparatuses of the type of a rear-mounted bicycle rack, ski rack, baggage rack, baggage carrier for motor vehicles are widespread, and have a structure with a cantilevered base in the configuration for use, which is fixed to the tow hook by way of adapted fastening means.

The base has a frame on which slots are then associated which are adapted to accommodate bicycles and, or bars and elements for holding skis or snowboards and, or bars and fixing elements for baggage.

Such conventional apparatuses have the drawback of not allowing the door of the baggage compartment (the rear door) of the motor vehicle to be opened once it is installed and loaded.

In order to overcome this drawback, types of bicycle rack, ski rack, baggage rack, baggage carrier are known which have a variable-configuration base.

Among the conventional types of bicycle rack, ski rack, baggage rack, baggage carrier, nowadays on the market there are two types of variable-configuration base:
the base with a frame that slides horizontally,
the base with a frame that is at least partially tiltable.

The base with a horizontally sliding frame has a structure provided with translation means which comprise at least one horizontal guide on which the frame can translate horizontally.

This type of base is mainly used on motor vehicles that have one or two rear doors, which are opened by rotating about a vertical axis such as, for example, in a van.

The base with an at least partially tiltable frame has a structure provided with one or two arms which extend horizontally in the configuration for use, at the ends of which the frame is hinged. The frame is arranged on a plane parallel to the arms during the movement of the motor vehicle, and is rotatable about a horizontal axis which is coplanar with the plane of arrangement of the arms.

This type of base is used mainly on motor vehicles that have one rear door which is opened by rotating about a horizontal axis, such as, for example, in an automobile.

These conventional techniques also have a number of drawbacks.

In fact, neither of the two types of bases described above is universal, even though it allows the door of some specific types of motor vehicles to be opened.

This means that the consumer who owns two types of motor vehicle, for example an automobile and a van, has to buy two different types of apparatus.

Similarly, a consumer who changes their motor vehicle for another of a different type may find it necessary to buy a new type of rear-mounted bicycle rack, ski rack, baggage rack, baggage carrier so that they will be able to open the rear door.

Furthermore, the presence on the market of such two different types of bases obliges the retainers to allocate considerable storage space to stock them.

### BRIEF SUMMARY OF THE DISCLOSURE

The aim of the present invention is to provide a base for a rear-mounted bicycle rack, ski rack, baggage rack, baggage carrier for a motor vehicle which is capable of improving the known art in one or more of the above-mentioned aspects.

Within this aim, an object of the invention is to provide a base for a rear- mounted bicycle rack, ski rack, baggage rack, baggage carrier for a motor vehicle that is universal and can be installed on any type of motor vehicle while still allowing the rear door to be opened, whether it opens by rotation about a vertical axis, or it opens by rotation about a horizontal axis.

Another object of the invention is to provide a base for a rear-mounted bicycle rack, ski rack, baggage rack, baggage carrier for a motor vehicle that allows retailers to reduce the storage space necessary to stock rear-mounted bicycle rack, ski rack, baggage rack, baggage carrier apparatuses for a motor vehicle.

Furthermore, the present invention sets out to overcome the drawbacks of the background art in a manner that is alternative to any existing solutions.

Another object of the invention is to provide a base for a rear-mounted bicycle rack, ski rack, baggage rack, baggage carrier for a motor vehicle that is highly reliable, easy to implement, and at low cost.

This aim and these and other objects which will become better apparent hereinafter are achieved by a base for a rear-mounted bicycle rack, ski rack, baggage rack, or baggage carrier for a motor vehicle which includes: a portion for association with a tow hook of the motor vehicle; and a frame. The base includes means for a horizontal translation of the frame, and means for a rotation of the frame about a substantially horizontal axis.

### BRIEF DESCRIPTION OF THE DRAWINGS

Further characteristics and advantages of the invention will become better apparent from the detailed description that follows of a preferred, but not exclusive, embodiment of the base for a rear-mounted bicycle rack, ski rack, baggage rack, baggage carrier for a motor vehicle according to the invention, which is illustrated for the purposes of non-limiting example in the accompanying drawings wherein:

FIG. 1 is an overall perspective view of a rear-mounted bicycle rack for a motor vehicle with a base according to the invention, in the configuration for use;

FIGS. 2 to 4 are side views of the bicycle rack of FIG. 1 in three different configurations for use;

FIGS. 5 to 7 are perspective views of the base for a rear-mounted bicycle rack, ski rack, baggage rack, baggage carrier for a motor vehicle, according to the invention, in three configurations for use, each one corresponding to a respective configuration of the bicycle rack shown in FIGS. 2 to 4;

FIG. 8 is an overall perspective view of a rear-mounted baggage rack for a motor vehicle with a base according to the invention, in the configuration for use.

### DETAILED DESCRIPTION OF THE DISCLOSURE

With reference to the figures, a base for a rear-mounted bicycle rack, ski rack, baggage rack, baggage carrier for a motor vehicle, according to the invention, is generally designated by the reference numeral 10.

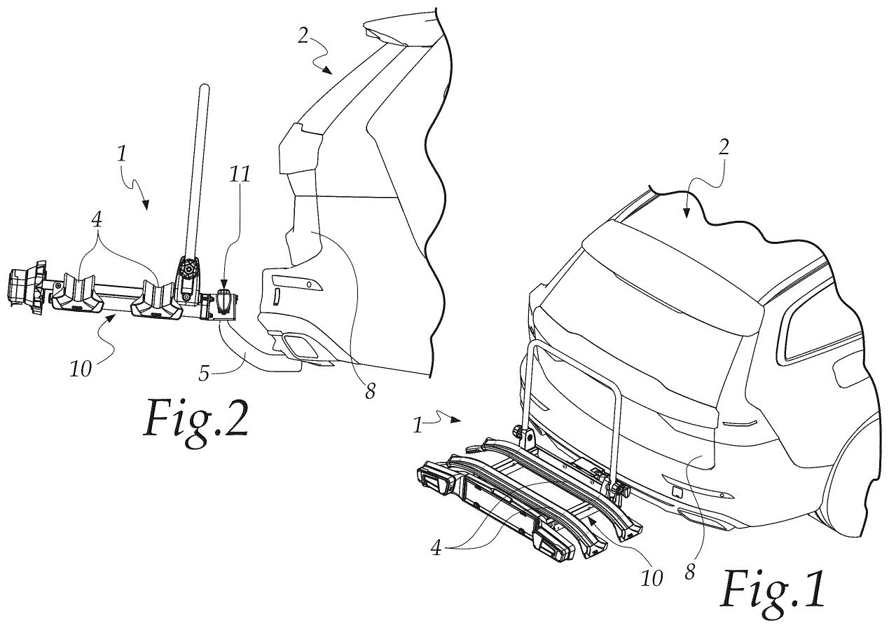

In FIGS. 1 to 4, the base 10 is used in a rear-mounted bicycle rack 1 for a motor vehicle 2.

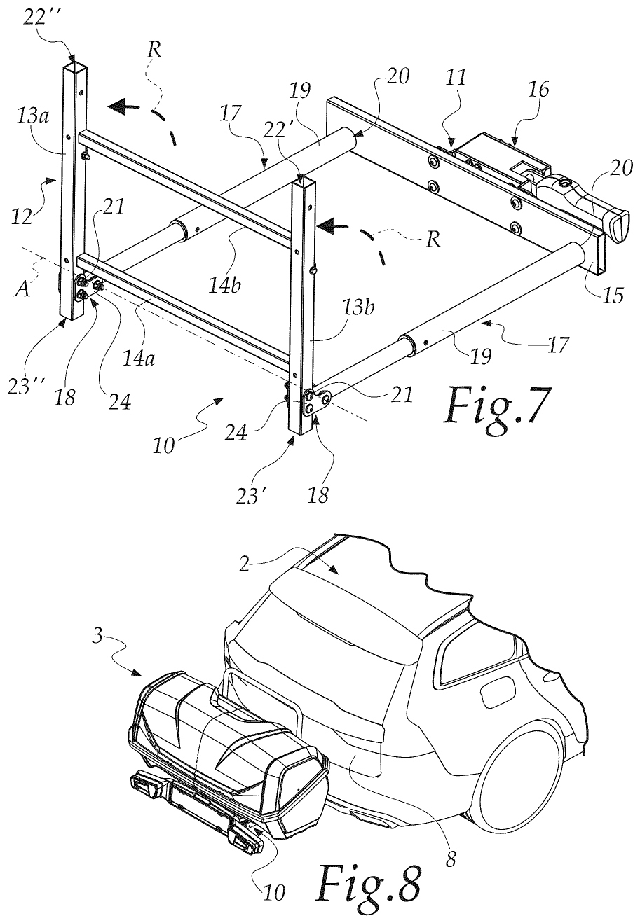

However, the base 10, according to the invention, can also be used in other types of apparatus, such as for example:
a rear-mounted baggage rack 3 for a motor vehicle 2, shown in FIG. 8, or the like,
a ski rack, not shown in the figures.

The base 10 comprises:
a portion 11 for association with the tow hook 5 of the motor vehicle 2,
a frame 12.

The frame 12 is arranged on a plane that is substantially horizontal in the configuration for movement of the motor vehicle 2.

The frame 12 is adapted to fix and support:
slots 4 for accommodating bicycles, for the bicycle rack 1,
and, or bars and elements for holding skis or snowboards and, or bars and elements for fixing a trunk and baggage carrier, not shown in the figures.

The frame 12 is constituted by:
two first bars 13a, 13b, parallel,
two second bars 14a, 14b, parallel, each one extending between the two first bars 13a, 13b, at right angles thereto.

Advantageously, the first bars 13a, 13b and the second bars 14a, 14b are monolithic.

The portion 11 for association with the tow hook 5 of the motor vehicle 2 has:
a third bar 15,
means 16 for fixing and fastening to the tow hook 5, which extend from the third bar 15.

The means 16 for fixing and fastening to the tow hook 5 extend from a first side of the third bar 15 and are of a type that is per se known, for example of the type comprising a lever mechanism (not shown in the figures) for closing and opening a pair of jaws around the ball of the tow hook 5 (also not shown in the figures).

One of the peculiarities of the invention consists in that the base 10 comprises:
means 17 for the horizontal translation of the frame 12,
and means 18 for the rotation of the frame 12 about a substantially horizontal axis A.

In particular, the means 17 for the horizontal translation of the frame 12 comprise at least one telescopic arm 19, which is substantially horizontal in the configuration for use.

Advantageously, the means 17 for the horizontal translation of the frame 12 comprise two telescopic arms 19, each one of which extends from a second side of the third bar 15, opposite to its first side, from which the means 16 extend for fixing and fastening to the tow hook 5.

The frame 12 is arranged, in the configuration for use and movement of the motor vehicle 2, on a plane that is substantially horizontal and parallel to the plane of arrangement of the two arms 19.

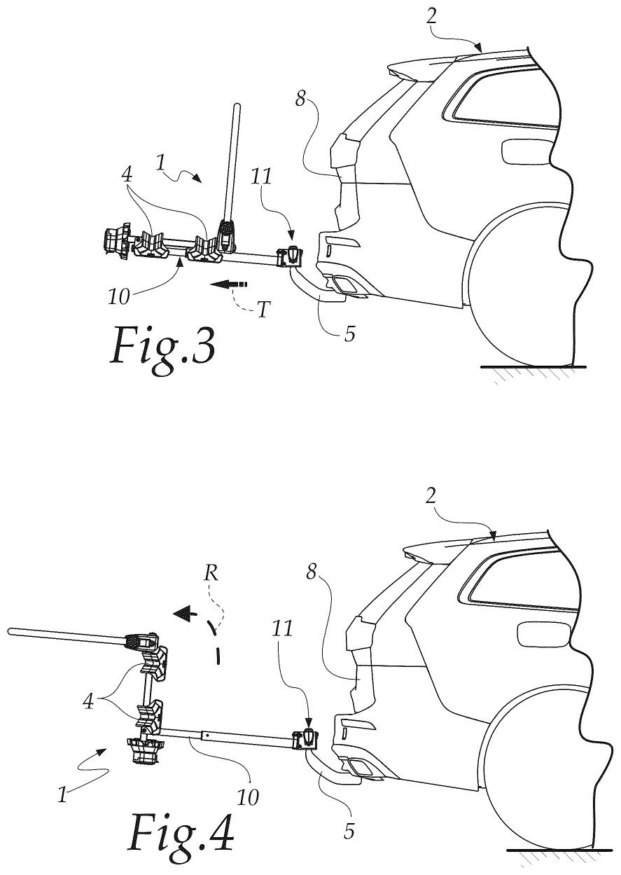

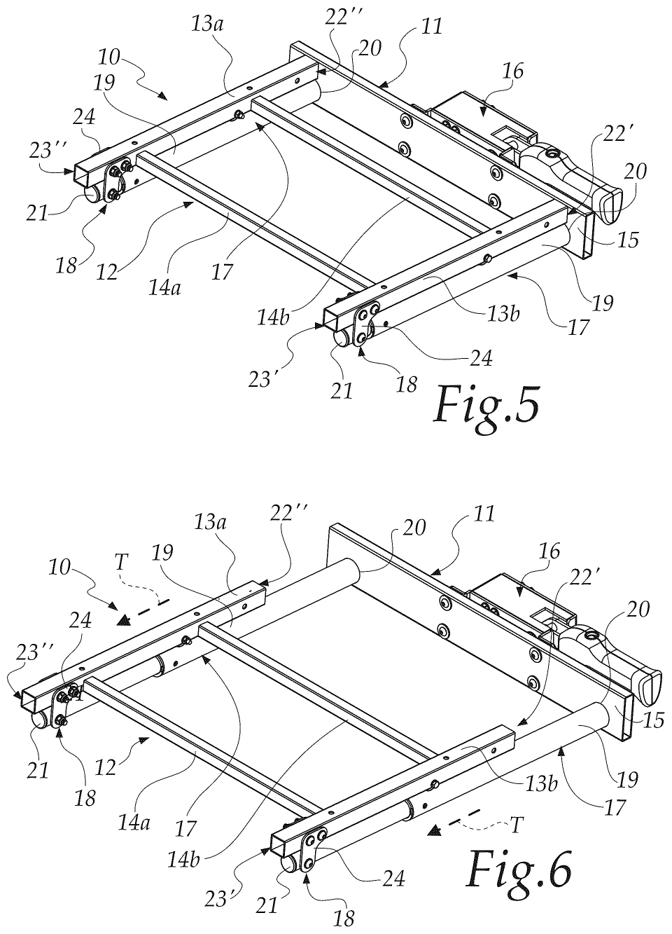

In the present description, the expression “configuration for use and movement of the motor vehicle” means the configuration that the base assumes during the normal movement of the motor vehicle, shown in particular in FIGS. 2 and 5.

The telescopic arms 19 have:
a first end 20, associated with the third bar 15,
a second end 21, coupled to a respective first bar 13a, 13b of the frame 12.

The first bars 13a, 13b each have:
a first end 22′, 22″, directed toward the third bar 15, in the configuration for use and for movement of the motor vehicle 2,
a second end 23′, 23″, opposite to the preceding one.

The means 18 for the rotation of the frame 12 comprise one or more hinge elements 24, each one for a respective arm 19.

In particular, each hinge element 24 is associated with and mutually couples:
the second end 21 of a respective arm 19,
the second end 23′, 23″ of a respective first bar 13a, 13b.

The base 10 also has:
means for preventing the rotation of the frame 12 about the axis A, not shown in the figures, in order to prevent the rotation of the frame during the movement of the motor vehicle 2, for example constituted by abutment elements defining seats that are shaped to match the first ends 22′, 22″ of the first bars 14a, 14b, when the base 10 is in the configuration for use and for movement of the motor vehicle 2,
means for preventing the horizontal translation of the frame 12, also not shown in the figures, for example comprising snap-acting elements which interact with the first ends 22′, 22″ of the first bars 14a, 14b when the base 10 is in the configuration for use and movement of the motor vehicle 2, and which can be disengaged by means of a special lever and/or handle in order to allow the translation of the frame 12.

The use of the base 10 according to the invention is the following.

When it is necessary to open the door 8 of the motor vehicle 2, the frame 12 is slid horizontally using the arms 19, along the direction indicated by the arrows T in FIGS. 3 and 6, then it is rotated about the axis A, along the direction indicated by the arrows R in FIGS. 4 and 7, using the hinge elements 24.

In this manner, the base 10 enables the rear-mounted bicycle rack, ski rack, baggage rack, baggage carrier for a motor vehicle to allow the rear door to be opened:
whether the door is of the type that opens by rotating about a vertical axis,
or the door is of the type that opens by rotating about a horizontal axis.

In practice it has been found that the invention fully achieves the intended aim and objects by providing a universal base for a rear-mounted bicycle rack, ski rack, baggage rack, baggage carrier for a motor vehicle, which can be installed on any type of motor vehicle while still allowing the rear door to be opened, whether it opens by rotation about a vertical axis, or it opens by rotation about a horizontal axis.

With the invention a base for a rear-mounted bicycle rack, ski rack, baggage rack, baggage carrier for a motor vehicle has been provided that allows retailers to reduce the storage space necessary to stock rear-mounted bicycle rack, ski rack, baggage rack, baggage carrier apparatuses for a motor vehicle.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

What is claimed is:

1. A base for a rear-mounted bicycle rack, ski rack, baggage rack, or baggage carrier for a motor vehicle, the base comprising:
a portion for association with a tow hook of the motor vehicle; and
a frame,
wherein the base comprises
means for a horizontal translation of the frame, and
means for a rotation of the frame about a substantially horizontal axis.

2. The base according to claim 1, wherein the frame comprises:
two first parallel bars; and
two second parallel bars, each of the second parallel bars extending between the two first parallel bars at right angles thereto.

3. The base according to claim 2, wherein the portion for association with the tow hook of the motor vehicle comprises:
a third bar; and
means for fixing and fastening to the tow hook, which extends from a first side of the third bar.

4. The base according to claim 1, wherein the means for the horizontal translation of the frame comprises at least one telescopic arm which is substantially horizontal in a configuration for use.

5. The base according to claim 3, wherein the means for the horizontal translation of the frame comprises two telescopic arms, each of the telescopic arms extending from a second side of the third bar opposite the first side of the third bar.

6. The base according to claim 5, wherein the frame is arranged, in a configuration for use and movement of the motor vehicle, on a plane that is substantially horizontal and parallel to a plane of arrangement of the two telescopic arms.

7. The base according to claim 5, wherein the two telescopic arms comprise:
a first end associated with the third bar; and
a second end coupled to a respective one of the first parallel bars of the frame.

8. The base according to claim 3, wherein the first parallel bars each comprise:
a first end, directed toward the third bar, in a configuration for use and for movement of the motor vehicle; and
a second end opposite to the first end.

9. The base according to claim 5, wherein the means for the rotation of the frame comprise one or more hinge elements, each for a respective one of the telescopic arms.

10. The base according to claim 9, wherein each one of the one or more hinge elements is associated with and mutually couples:
the second end of a respective one of the telescopic arms; and
the second end of a respective one of the first parallel bars.
